(19) United States
(12) Patent Application Publication
(10) Pub. No.: US 2003/0152741 A1
(43) Pub. Date: Aug. 14, 2003

(54) Patterned polyurethane foam and a process for the production of tufted goods with patterned foam backing

(76) Inventors: Jeffrey L. Robbins, Chattanooga, TN (US); Ulrich B. Holeschovsky, Sewickley, PA (US)

Correspondence Address: BAYER POLYMERS LLC, 100 BAYER ROAD, PITTSBURGH, PA, 15205, US

(21) Appl. No.: 10/068,123

(22) Filed: Feb. 5, 2002

(51) Int. Cl. B32B 33/00

(52) U.S. Cl. 428/95; 156/324; 427/277; 427/358

(57) ABSTRACT

This invention relates to a process for the production of patterned polyurethane foam as a backing for tufted goods. This process comprises applying a puddle of a reactive polyurethane mixture to the back side of a greige good, passing the greige good coated with the reactive polyurethane mixture under a doctoring device and curing the polyurethane backed greige good. In one embodiment of the present invention, the doctoring device is patterned or an attachment to the doctoring device is patterned, and forms a corresponding pattern in the polyurethane coating as it passes under the doctoring device. In another embodiment, a woven secondary backing is laminated to the reactive polyurethane mixture after passing under the doctoring device, and pressure is applied against the face of the tufted good such that the urethane is pushed through the windows of the secondary backing. This pressure forms beads of polyurethane on the underside of the woven secondary backing.

### BACKGROUND OF THE INVENTION

This invention relates to a process for production of tufted goods with a patterned polyurethane backing. This process comprises applying a puddle of a reactive polyurethane formulation to the back side of a greige good, passing the greige good coated with the reactive polyurethane formulation under a doctoring device and curing the polyurethane backed greige good.

In one embodiment of the present invention, the pattern in the polyurethane backing is formed as it passes underneath the patterned edge of the doctoring device. In another embodiment, a woven secondary backing is laminated to the reactive polyurethane formulation after passing under the doctoring device, and pressure is applied against the face of the tufted good such that the urethane is pushed through the windows of the secondary backing. This pressure forms beads of polyurethane foam on the underside of the woven secondary backing.

The manufacture of carpet by implanting tufts in an adhesive composition spread on a backing material is known and described, for example, in British Patent 1,121,036. This process requires the adhesive to be applied to a moving web of backing material in such a way as to form a uniform layer. A doctor blade, also commonly referred to as a doctor bar, is typically used to spread the adhesive or coating into a layer on the back of the greige good. In order to accommodate variations in the thickness of the greige good, backing material and/or in the desired adhesive layer, the doctor blade is mounted in an adjustable manner that allows it to be moved towards and away from a structural element (i.e., a bedplate) over which the web of material passes.

U.S. Pat. No. 5,036,793 describes a doctor blade apparatus in which the adjustment means is simplified. A gap of pre-determined height is defined between the doctor blade and the bedplate to allow the web of material to pass through, and the height of this gap is adjusted by an actuator for moving the base member (or bedplate) towards and away from the doctor blade assembly. The only pattern that can be formed in the polyurethane backing when using the apparatus of U.S. Pat. No. 5,036,793 is a pattern that corresponds to that on the face of the greige good. If no pattern is present on the face of the greige good, no pattern results in the backing.

U.S. Pat. No. 6,264,775 describes a process for the preparation of tufted carpeting wherein a tuft bind adhesive is applied to the tufts penetrating a primary backing, wherein the tuft bind adhesive comprises a polyurethane adhesive and one or more drip reducing processes. The polyurethane adhesive comprises one or more isocyanate-functional components and one or more isocyanate-reactive components. Suitable tuft bind adhesives comprise polyurethane adhesives containing non-Newtonian thickeners, or viscosity index improving additives. This process allows for the drip-free, face-up cure of carpeting prepared using polyurethane adhesives.

In some application areas it is desirable to produce detached or attached foam with a pattern. There are a wide variety of designs such as ribs or waffle iron style patterns. Often these patterns are used to reduce sliding of decorative mats. When latex is used, the pattern can be realized by using an embossing roller that is pressed into the still wet latex, typically right before the coated greige good is entering the curing oven. This technology could theoretically also be used for urethane foam, however, it is very difficult to practice since the reactive urethane mixture tends to stick to the embossing roller. When using urethane backings, it is only possible to use an embossing roller if it is used exactly at the point at which there is a sufficient urethane skin to minimize sticking to the embossing roller while the core of the material is still liquid.

Patterned foams made with urethane would be highly desirable for applications in which the coated good is directly exposed to water or high levels of humidity because of the inherent resistance to water of urethane. Examples are mats used in bathrooms, carpets for boats and recreational vehicles. Latex foams or cushions typically disintegrate after a limited number of wetting and drying cycles. This invention discloses practical and easily implemented methods to produce patterned urethane foams.

### SUMMARY OF THE INVENTION

This invention relates to a process for the preparation of a polyurethane backed tufted good wherein the polyurethane backing has a pattern formed therein. This process comprising applying a puddle of a reactive polyurethane formulation to the back side of a greige good, wherein the greige good may be uncoated, coated with cured latex, or coated with an urethane precoat which may be cured, partially cured or uncured; passing the greige good coated with the reactive polyurethane formulation under a doctoring device; and curing the polyurethane backed greige good.

In one embodiment of the present invention, the edge of the doctoring device which contacts the polyurethane formulation as it passes underneath the doctoring device is patterned so that a corresponding pattern is formed in the polyurethane formulation as it passes underneath the doctoring device, and remains in the polyurethane formulation as it passes through the curing oven. This pattern in the edge of the doctoring device may be formed, for example, by actually cutting the desired pattern into the edge of the doctoring device, or by employing a removable attachment to the edge of the doctoring device wherein the attachment has the desired pattern cut into it.

In another embodiment of the present invention, a woven secondary backing is laminated to the reactive polyurethane formulation after it has passed underneath the doctoring device, and pressure is then applied against the face of the tufted good such that the urethane is pushed through the windows of the woven secondary backing. This forms beads or ribs of the polyurethane coating on the exposed surface of the woven secondary backing. At some point after this, the greige good is cured.

Suitable reactive polyurethane formulations for the present invention comprise:

(a) at least one polyisocyanate component,

(b) at least one isocyanate-reactive component,

(c) at least one non-Newtonian thickener, and

(d) at least one filler.

The present invention also relates to polyurethane backed tufted goods wherein the back surface of the tufted good exhibits a pattern.

In one embodiment, the polyurethane backed tufted good which exhibits a pattern on the back surface comprises: (A) a greige good comprising one or more fibers tufted into a primary backing, the greige good having a face surface and a back surface, wherein the back surface of the greige good may be uncoated, coated with a cured latex precoat, or coated with a cured urethane precoat; and (B) a polyurethane backing having a face surface and a back surface, wherein the face surface of the polyurethane backing is adhered to the back surface of the greige good or the precoat when present, and the backing comprises a polyurethane formulation comprising: (1) at least one polyisocyanate component, (2) at least one isocyanate-reactive component, (3) at least one non-Newtonian thickener, and (4) at least one filler; wherein the pattern present on the back surface of the polyurethane backing is formed by passing the greige good coated with the uncured polyurethane formulation under a doctoring device having the desired pattern present on the edge of the doctoring device. As described above, the edge of the doctoring device may be patterned by actually cutting the desired pattern into the edge of the doctoring device which contacts the polyurethane formulation as it passes underneath the doctoring device, or by employing a removable attachment along the edge of the doctoring device, wherein the removable attachment which has the desired pattern on the edge which contacts the polyurethane formulation as it passes underneath the doctoring device.

In another embodiment, the polyurethane backed tufted good which exhibits a pattern on the back surface, comprises (A) a greige good comprising one or more fibers tufted into a primary backing, the greige good having a face surface and a back surface, wherein the back surface of the greige good may be uncoated, coated with a cured latex precoat, or coated with a cured urethane precoat; (B) a polyurethane backing having a face surface and a back surface, wherein the face surface of the polyurethane backing is adhered to the back surface of the greige good or of the precoat when present, and the polyurethane backing comprises a polyurethane formulation comprising: (1) at least one polyisocyanate component, (2) at least one isocyanate-reactive component, (3) at least one non-Newtonian thickeners, and (4) at least one filler; and (C) a woven secondary backing which is laminated to the back surface of the polyurethane backing component; wherein the pattern is formed by the application of pressure or force to the face of the greige good in a manner that pushes some of the polyurethane backing component through the windows of the woven secondary backing prior to curing of the polyurethane backing component.

### BRIEF DESCRIPTION OF THE DRAWINGS

FIG. 1 illustrates a two puddle polyurethane-based carpet laminating system.

### DETAILED DESCRIPTION OF THE INVENTION

As used herein, the term tufted goods refers to carpets and artificial turf.

The tufted goods of the present invention are initially prepared in the conventional manner, the greige good being constructed by tufting yarns into a primary woven or non-woven backing of jute, polypropylene, or the like. Optionally, the greige good may have a urethane or latex precoat. In case the precoat is latex, it needs to be fully cured. Typically, the pH of a latex precoat needs to be higher than 9 to allow good adhesion to the urethane. In cases where the precoat applied to the greige good comprises a urethane precoat, it is possible for this precoat to be fully cured, partially cured or uncured. The greige good, whether it is precoated or not, is then contacted with the reactive polyurethane, which is mechanically frothed.

The polyurethane mixture may be applied to the back of the greige good or to the back of the precoat on the greige good by a supply hose or other conventional methods, including dipping, spraying, etc. The frothing of the reactive mixture may be accomplished by using a frothing apparatus, for example an Oakes or Firestone froth head.

The reactive mixtures are typically frothed to various degrees, depending on the desired density. Frothing of the formulations described above can be accomplished as described in, for example, U.S. Pat. No. 5,604,267, the disclosure of which is herein incorporated by reference. Frothing may also be accomplished in the conventional manner by introducing the reactive ingredients together with a substantially inert gas such as air, nitrogen, argon, carbon dioxide, or the like, into a froth mixer such as an Oakes or Firestone mixer. The frothed mixtures are generally gauged with a doctoring device such as, for example, a doctor blade or roller, or the like, to the desired thickness. Frothed mixtures may also include a volatile or reactive blowing agent, most preferably water, in addition to being mechanically frothed, to produce a foam with a relatively low density.

The reactive polyurethane systems comprise one or more di- or polyisocyanates (i.e. an A-side), and an isocyanate-reactive component (i.e. a B-side) which comprises one or more polyols, generally polyols having nominal functionalities of from 2 to 8, one or more low molecular weight chain extenders and/or crosslinkers, one or more polyurethane-promoting catalysts, and, optionally, components including suitable surfactants, plasticizers, pigments, and other well known polyurethane additives. In general, a filler is also employed. Preferred reactive polyurethane systems to be used in the present invention are described in detail in, for example, U.S. Pat. Nos. 5,462,766, 5,558,917, 5,723,194, 6,171,678 and 6,265,775, the disclosures of which are herein incorporated by reference.

The mineral fillers suitable for the present invention are those conventionally used including, in general, ground limestone, dolomite, alumina trihydrate, etc. The fillers are of relatively large particle size, for example commonly in the range of 15 μm to 100 μm, and thus have low specific (BET) surface area. The surface area of such fillers is, in general, less than 5 m²/g. Amounts of filler vary quite widely, but amounts of from 50 parts to 300 parts of filler per 100 parts of isocyanate-reactive components, preferably from 150 parts to 220 parts of filler per 100 parts of isocyanate-reactive components, are typical. It should be noted that these fillers do not cause any substantial non-Newtonian behavior.

The non-Newtonian thickeners may be any thickener which exhibits a substantial inverse relationship between shear and viscosity. In general, inorganic particulates having BET surface areas greater than about 10 m²/g, preferably greater than 40 m²/g, more preferably greater than 100 m²/g, and yet more preferably 200 m²/g or more, are suitable. The thickeners may be hydrophobic or hydrophilic in nature. Examples include precipitated calcium carbonate, finely divided clays, preferably smectite or “layered” clays, and precipitated and “fumed” silicas, i.e., silicas produced by flame pyrolysis processes and the like. Such thickeners are well known and available from numerous sources, including General Electric, Dow Corning Silicones, Wacker-Chemie GmbH and Wacker Silicones Corporation, Rhone-Poulenc, and Degussa, among others. Inorganic thickeners are used in amounts which preferably at least double the resting viscosity as opposed to the viscosity exhibited under a shear rate of 50 sec⁻¹. More preferably, the rest viscosity at 25° C. is more than three times the viscosity at a shear rate of 50 sec⁻¹ or more, and most preferably more than ten times this viscosity.

Since the action of non-Newtonian particulate thickeners is due, at least in part, to surface infractions, the nature of the surface will cause the amount of thickener as well as its overall effect to vary somewhat. However, adjustment of the amount of thickener can be easily accomplished.

Some particular thickeners such as fumed silica have relatively small particle sizes, and are highly efficient non-Newtonian thickeners. For example, Aerosil® 200 or Cabosil-M5®, with average primary particle sizes of 0.012 μm are only required in relatively small amounts. The upper limit (UL) of the fumed silica depends on the amount of filler (i.e. filler level, FL) per 100 parts of the isocyanate-reactive components, as shown in the following equation:

UL=8−(0.02×FL)

The lower limit (LL) is determined by the following equation:

LL=3−(0.01×FL)

Precipitated and surface treated calcium carbonate, such as Thixocarb 500 (commercially available from Specialty Minerals Inc., Adams, Mass.), with an average particle size of 0.15 μm, follow similar relationships, however, because of their larger particle size, the required usage levels are approximately 6 times higher than for fumed silica.

In general, inorganic particulate thickeners average particle size must be less than 1 μm, preferably less than 0.3 μm, and most preferably less than 0.1 μm. The usage levels are typically inversely related to the amount of filler used because these thickeners create bridges between the much larger filler particles often via hydrogen bonding among other mechanisms. Hence, filler and thickening agent create a structure in which the filler particles are all connected via bridges. As more filler is present in the mixture, the distance between the filler particles is lowered and thus, less thickener is needed to bridge the gap between filler particles.

Organic thickeners which display non-Newtonian characteristics are also useful. An expedient way to test a particular thickener for its non-Newtonian thickening ability is to add the thickener to a target polyurethane adhesive “B-side” (resin side), and measure its viscosity at different levels of shear. Thickeners which exhibit a substantial inverse relationship between viscosity and shear are non-Newtonian. Candidate thickeners include the various vegetable gums, i.e. carrageenan, tragacanth, acacia, guar, and the like; modified celluloses, e.g., carboxymethylcellulose, carboxypropylcellulose, hydroxymethylcellulose, and the like; polyacrylic acid polymers and copolymers with acrylates and other unsaturated monomers, e.g., the Carbopol® and Acrysol® thickeners; very high molecular weight polyethers, such as high molecular weight polyoxyethylene glycol, and the like. Associative thickeners may be particularly effective. Associative thickeners are molecules which have a hydrophobic or non-polar portion and a hydrophilic, polar, or ionic portion. In solution, the non-polar portions tend to associate with each other, as do the hydrophilic, polar, or ionic portions, forming extraordinarily long “associative” chains and networks. The interactions are easily broken by shear, however, and thus the molecules exhibit decidedly non-Newtonian behavior. Combinations of organic non-Newtonian and inorganic non-Newtonian thickeners may be used as well. Examples of non-Newtonian thickeners may be found in U.S. Pat. Nos. 4,709,099 and 4,649,224, the disclosures of which are herein incorporated by reference. It is possible to tailor the properties of certain of the polyols to serve as non-Newtonian thickeners.

Suitable secondary backings to be used in the present invention include those that are known in the art and are commonly used in the production of carpeting, artificial turf and other tufted goods. Most preferably are secondary backings such as Actionbac® that have evenly spaced openings to produce a uniform pattern in the urethane.

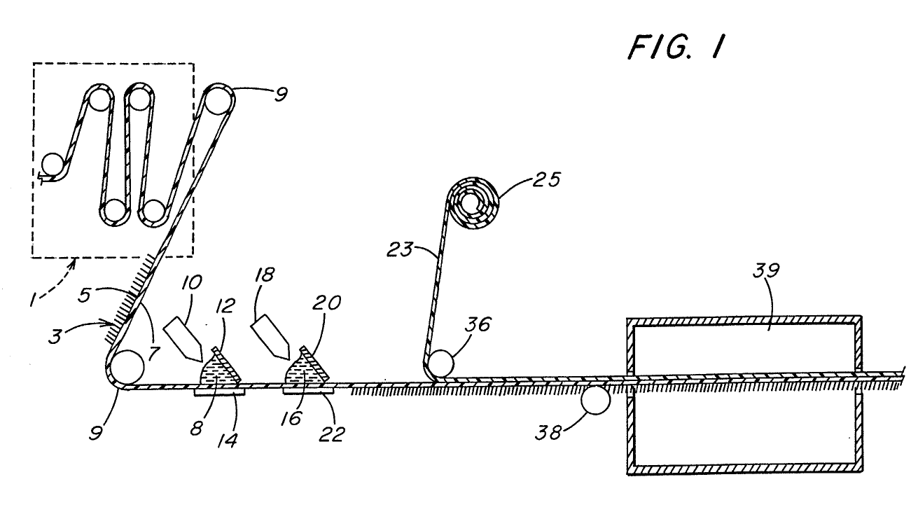

FIG. 1 illustrates a commercial two puddle polyurethane system. In the dashed box labeled 1, preliminary carpet operations such as correction of bowing and skewing, which do not form a part of the coating and/or laminating processes per se, are practiced. The greige good 3, with carpet exterior 5 and the reverse side 7 is redirected by means of rollers 9 to place the reverse side of the greige goods facing up. To the reverse side 7 of the greige good 3, a polyurethane is applied from puddle 8, supplied with a reactive polyurethane mixture through supply line 10. Doctor blade 12, in cooperation with platen 14, limits the applied weight of polyurethane and forces it into the greige goods. The “puddles” 8 and 16 collect prior to the doctor blades 12 and 20, respectively. Puddle 8 is an optional embodiment since, in some cases, a separate precoat may not be applied to the reverse side of the greige goods in the present invention. Obviously, when the present invention does not have a precoat applied to the reverse side of the greige goods, then puddle 8, supply line 10, doctor blade 12 and platen 14 are not present. Other possibilities include situations in which the precoat, either urethane or latex, has already been applied and cured in an earlier processing step. Also, it is possible to have a curing oven or curing station (not shown in FIG. 1) after the first doctor blade 12 and before the supply line 18 which supplies the reactive polyurethane mixture to form the puddle 16, for complete or partial curing of the polyurethane from the first puddle 8. If a curing oven or curing station is present after the doctor blade 12 and before the supply line 18 which forms puddle 16, a precoat adhesive comprising a latex formulation could be applied through supply line 10 as puddle 8.

In accordance with the present invention, following the optional first puddle 8 is a second polyurethane puddle 16, supplied with a reactive polyurethane mixture from supply line 18. The doctor blade 20, in conjunction with a platen 22, adjusts the thickness of the deposited polyurethane mixture.

In one embodiment of the present invention, either the edge of the doctor blade 20 itself or a removable attachment attached to the doctor blade 20 is patterned, and thus cuts or forms a corresponding pattern in the urethane froth as it passes underneath the edge of the doctor blade 20 or the attachment on the doctor blade 20. In addition, it is also possible to provide a mechanism to move the patterned doctor blade or the doctor blade with the patterned attachment laterally back and forth to create a zigzag pattern. In this embodiment, a woven secondary backing 23 is optional. When a secondary backing is not present, supply roll 25, roller 36 and roller 38 are also optional. After the urethane backed greige good passes underneath the doctor blade 20 and across platen 22, at some later point downstream, it enters into and passes through the curing oven 39.

In an alternate embodiment of the present invention, the doctor blade 20 is straight (i.e. free of any pattern) and a woven secondary backing 23, supplied from supply roll 25, contacts the urethane froth below roller 36. Prior to entry into the curing oven 39, at least one roller(s) 38 pushes the face of the greige good 3 up slightly such that the pressure exerted pushes the urethane through the openings of the woven secondary backing, thus creating beads or ribs of polyurethane foam on the exterior surface of the secondary backing 23. By varying the height of the roller(s) 38, the height of the beads formed on the exterior surface of the secondary backing 23 can be controlled. Curing the laminate is accomplished by passing through the curing oven 39. As is typical in polyurethane backed greige goods, the greige good is cured face side down.

In the embodiment employing a secondary backing described above, a precoat may or may not be applied to the reverse side of the greige good as previously described. Suitable precoats may be urethane or latex, and may be cured, partially cured or uncured as previously described. For example, a urethane precoat can be supplied through supply line 10 as puddle 8, which then passes under doctor blade 12. This optional urethane precoat may be uncured or partially cured, in which case, the reactive polyurethane mixture is applied to the back of the precoated greige good as puddle 16 through supply line 18, which then passes under doctor blade 20. It is also possible that the precoat comprises urethane or latex which is cured by passing through a curing oven (not shown) before the reactive polyurethane mixture forming the polyurethane backing is supplied as puddle 16 to the back of the precoated greige good through supply line 18 before passing under the doctor blade 20, followed by contacting with the secondary backing 23 from supply roll 25 to the urethane froth below roller 36. There are, of course, numerous other variations in this embodiment of the present invention.

In the foregoing embodiment(s), the figure has been simplified for ease of viewing and understanding. In commercial embodiments, various tension controlling devices, tenter frames, drive motors, etc. will be required, as is well known to those skilled in the art.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all parts and percentages are parts by weight and percentages by weight, respectively.

### EXAMPLES

Comparative Examples are Examples C1, C2 and C3, and Examples representative of the present invention are Examples 1, 2 and 3.

The ingredients shown in Table 1 were frothed in a kitchen mixer using a wire mesh impeller. To the frothed mixture was added and mixed for 1 minute, 45 parts of Baytuft® 751 (a polyisocyanate having an NCO group content of about 27.5%), which resulted in a NCO/OH group ratio of 1.04, (104 Index). The froth was then applied to a nylon loop-pile greige good and gauged using a trowel with teeth ¼″ deep along the edge of the trowel and spaced ¼″ apart, thereby creating a ribbed polyurethane backing. In the comparative examples (C1, C2 and C3), the ribs started to immediately flow into the grooves, creating rounded edges, while the pattern in all the other examples (Examples 1, 2 and 3) remained well defined. The coated greige goods were cured for about 6 minutes at 150° C. All comparative examples showed complete disappearance of the ribs after curing, whereas Examples 1, 2 and 3 maintained well defined ribs.

TABLE 1

| | C1 | 1 | C2 | 2 | C3 | 3 |
|---|---|---|---|---|---|---|
| Atlantis ® Q1000 | 97 | 97 | 97 | 97 | 97 | 97 |
| Diethylene Glycol | 3 | 3 | 3 | 3 | 3 | 3 |
| LC 5615 catalyst | 1.6 | 1.6 | 1.6 | 1.6 | 1.6 | 1.6 |
| L 5614 Surfactant | 2 | 2 | 2 | 2 | 2 | 2 |
| Aerosil ® 200 | — | 4.5 | — | 3 | — | 2 |
| Calcium Carbonate | 100 | 100 | 150 | 150 | 200 | 200 |
| Filler | | | | | | |

| | |
|---|---|
| LC 5615 | a catalyst commercially available from Crompton |
| | Corp. |
| L 5614 | a silicone surfactant, commercially available from |
| | Crompton Corp. |
| Aerosil 200 | fumed silica, commercially available from Degussa, |
| Atlantis ® Q1000 | an isocyanate-reactive blend commercially available |
| | from Bayer Corp. |
| Baytuft ® 751 | a polyisocyanate having an NCO group content of |
| | about 27.5%, commercially available from Bayer |
| | Corp. |

### Example 4

The purpose of this run was to produce a foam backing that protruded through the windows of the secondary backing, giving the backing a beaded appearance. The beaded foam produced a no-skid surface, and also allows any water that may accumulate to gravity drain under the carpet between the urethane beads.

The formulation shown in Table 2 was run on a commercial-scale tenter-frame finishing line. These materials were mixed in a Firestone pin mixer and frothed with air to produce a cupweight of about 400 g/l. The greige good was a 12 ft wide, polypropylene cut-pile for marine use such as boats. The reactive mixture was applied to the reverse side of the greige good using a doctor bar. About 2 ft after passing the doctor bar and just before the greige good was attached to the tenters, a marriage roller was used to apply a 5 pic ActionBac® secondary backing. About 1 foot after the marriage roller and shortly after the greige good was attached to the tenters, a press roller was used to push up against the face of the carpet in between the tenter frame, thus forcing the foam to protrude through the opening of the secondary backing. Two more press rollers, the first placed about 40 ft after the doctor bar (i.e. right before the curing oven), and the second placed about 20 ft into the oven, were used to add additional definition to the beads. The greige good with the urethane backing exited the oven fully cured with clearly defined, well formed and evenly distributed beads protruding through the windows of the ActionBac® secondary backing. The applied weight of polyurethane was about 33 oz/yd².

TABLE 2

| | PBW |
|---|---|
| Atlantis Q1000 | 97 |
| Diethylene Glycol | 3 |
| LC 5615 Catalyst | 2 |
| L 5614 Surfactant | 2 |
| Cabosil ® M-5 | 2.6 |
| Calcium Carbonate | 150 |
| Baytuft ® 751 | 46 |
| Cabosil ® M-5 | a fumed silica, commercially |
| | available from Cabot Corp. |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the preparation of a patterned polyurethane backed tufted good comprising:
(1) applying a puddle of a reactive polyurethane mixture to the back side of a greige good or a precoated greige good, wherein the reactive polyurethane mixture comprises:
(a) at least one polyisocyanate component,
(b) at least one isocyanate-reactive component,
(c) at least one non-Newtonian thickeners, and
(d) at least one filler;
(2) passing the greige good coated with the reactive polyurethane mixture under a doctoring device, wherein the edge of the doctoring device is patterned or the doctoring device comprises a removable attachment that is patterned, thereby forming a pattern in the polyurethane mixture as it passes under the edge of the doctoring device or the removable attachment; and
(3) curing the polyurethane backed greige good which exhibits the desired pattern in the polyurethane backing.

2. The process of claim 1, wherein the doctoring device comprises a doctor blade, a doctor bar, or a doctor roller.

3. The process of claim 1, wherein said non-Newtonian thickener is an inorganic thickener having a specific surface area about 10 m²/g or greater.

4. The process of claim 3, wherein said inorganic thickener is present in an amount of from about 0.25 to 20 parts per 100 parts of isocyanate-reactive ingredients in the reactive polyurethane mixture.

5. The process of claim 3, wherein said inorganic non-Newtonian thickener is selected from the group consisting of precipitated calcium carbonate, clay minerals, fumed silica, and mixtures thereof.

6. The process of claim 3, wherein said inorganic non-Newtonian thickener comprises fumed silica and is present in an amount of at least:
LL=3−0.01×FL
wherein:
LL: represents lower limit for non-Newtonian thickener in parts per 100 parts of isocyanate-reactive components; and
FL: represents filler level in parts per 100 parts of isocyanate-reactive components;
and wherein the amount of non-Newtonian thickener is no more than:
UL=8−0.02×FL
wherein:
UL: represents upper limit for non-Newtonian thickener in parts per 100 parts of isocyanate-reactive components; and
FL: represents filler level in parts per 100 parts of isocyanate-reactive components.

7. The process of claim 3, wherein said inorganic non-Newtonian thickener comprises precipitated calcium carbonate and is present in an amount of at least:
LL=18−0.06×FL
wherein:
LL: represents the lower limit for non-Newtonian Newtonian thickener in parts per 100 parts of isocyanate-reactive components; and
FL: represents filler level in parts per 100 parts of isocyanate-reactive components;
and wherein the amount of non-Newtonian thickener is no more than:
UL=48−0.012×FL
wherein:
UL: represents the upper limit for non-Newtonian thickener in parts per 100 parts of isocyanate-reactive components; and
FL: represents filler level in parts per 100 parts of isocyanate-reactive components.

8. The process of claim 3, wherein said inorganic non-Newtonian thickener has a mean particle size less than 1 μm.

9. The process of claim 3, wherein said inorganic non-Newtonian thickener has a mean particle size less than 0.3 μm.

10. The process of claim 3, wherein said thickener forms aggregates and/or agglomerates.

11. The process of claim 1, wherein an organic non-Newtonian thickener is employed.

12. The process of claim 11, wherein said organic non-Newtonian thickener is an associative thickener.

13. The process of claim 1, wherein the viscosity of said reactive polyurethane formulation at a first, high rate of shear is within 20% of the viscosity of a reactive polyurethane of the same formulation but devoid of non-Newtonian thickener, and is at least three times the viscosity of the non-Newtonian thickener-devoid composition at a second, lower rate of shear.

14. The process of claim 1, additionally comprising laminating a woven secondary backing to the polyurethane coating of the desired pattern after (2) passing under the doctoring device.

15. The process of claim 1, wherein the precoated greige good is selected from the group consisting of a cured latex precoat, a cured urethane precoat, a partially cured urethane precoat and an uncured urethane precoat.

16. A process for the preparation of a polyurethane backed tufted good comprising:
(1) applying a puddle of a reactive polyurethane mixture to the back side of a greige good or a previously coated greige good, wherein the reactive polyurethane mixture comprises:
(a) at least one polyisocyanate component,
(b) at least one isocyanate-reactive component,
(c) at least one non-Newtonian thickeners, and
(d) at least one filler;
(2) gauging the greige good coated with the reactive polyurethane mixture with a doctoring device;
(3) laminating a woven secondary backing to the reactive polyurethane mixture;
(4) applying pressure against the face of the greige good such that the urethane is pushed through the windows of the woven secondary backing, thereby forming beads of polyurethane on the exposed surface of the woven secondary backing; and
(5) curing the polyurethane backed greige good.

17. The process of claim 16, wherein the doctoring device comprises a doctor blade, a doctor bar, or a doctor roller.

18. The process of claim 16, wherein said non-Newtonian thickener is an inorganic thickener having a specific surface area about 10 m²/g or greater.

19. The process of claim 18, wherein said inorganic thickener is present in an amount of from about 0.25 to 20 parts per 100 parts of isocyanate-reactive ingredients in the reactive polyurethane mixture.

20. The process of claim 18, wherein said inorganic non-Newtonian thickener is selected from the group consisting of precipitated calcium carbonate, clay minerals, fumed silica, and mixtures thereof.

21. The process of claim 18, wherein said inorganic non-Newtonian thickener comprises fumed silica and is present in an amount of at least:
LL=3−0.01×FL
wherein:
LL: represents lower limit for non-Newtonian thickener in parts per 100 parts of isocyanate-reactive components; and
FL: represents filler level in parts per 100 parts of isocyanate-reactive components;
and wherein the amount of non-Newtonian thickener is no more than:
UL=8−0.02×FL
wherein:
UL: represents upper limit for non-Newtonian thickener in parts per 100 parts of isocyanate-reactive components;
and
FL: represents filler level in parts per 100 parts of isocyanate-reactive components.

22. The process of claim 18, wherein said inorganic non-Newtonian thickener comprises precipitated calcium carbonate being present in an amount, per 100 parts of isocyanate-reactive components, of at least:
LL=18−0.06×FL
wherein:
LL: represents lower limit for non-Newtonian thickener in parts per 100 parts of isocyanate-reactive components; and
FL: represents filler level in parts per 100 parts of isocyanate-reactive components;
and wherein the amount of non-Newtonian thickener is no more than:
UL=48−0.12×FL
wherein:
UL: represents upper limit for non-Newtonian thickener in parts per 100 parts of isocyanate-reactive components; and
FL: represents filler level in parts per 100 parts of isocyanate-reactive components.

23. The process of claim 18, wherein said inorganic non-Newtonian thickener has a mean particle size less than 1 μm.

24. The process of claim 18, wherein said inorganic non-Newtonian thickener has a mean particle size less than 0.3 μm.

25. The process of claim 18, wherein said thickener forms aggregates and/or agglomerates.

26. The process of claim 16, wherein an organic non-Newtonian thickener is employed.

27. The process of claim 26 wherein said organic non-Newtonian thickener is an associative thickener.

28. The process of claim 16, wherein the viscosity of said reactive polyurethane formulation at a first, high rate of shear is within 20% of the viscosity of a reactive polyurethane of the same formulation but devoid of non-Newtonian thickener, and is at least three times the viscosity of the non-Newtonian thickener-devoid composition at a second, lower rate of shear.

29. The process of claim 16, wherein the precoated greige good is selected from the group consisting of a cured latex precoat, a cured urethane precoat, a partially cured urethane precoat and an uncured urethane precoat.

30. A polyurethane backed tufted good which exhibits a pattern on the back surface, and comprises:
(A) a greige good comprising one or more fibers tufted into a primary backing, said greige good having a face surface and a back surface wherein the back surface may be uncoated, or coated with a latex or urethane precoat; and
(B) a polyurethane backing having a face surface and a back surface, wherein the face surface of is adhered to the back surface of said greige good or the precoat when present, and said polyurethane backing is a reactive polyurethane mixture comprising:
(1) at least one polyisocyanate component,
(2) at least one isocyanate-reactive component,
(3) at least one non-Newtonian thickener,
and
(4) at least one filler;
wherein the pattern in the polyurethane backing is formed by passing the polyurethane backed greige good under a doctoring device, wherein the edge of the doctoring device is patterned or the doctoring device comprises a removable attachment that is patterned.

31. A polyurethane backed tufted good which exhibits a pattern on the back surface, and comprises
(A) a greige good comprising one or more fibers tufted into a primary backing, said greige good having a face surface and a back surface, wherein the back surface may be uncoated, coated with a latex or urethane precoat;
(B) a polyurethane backing having a face surface and a back surface, wherein the face surface is adhered to the back surface of said greige good or the precoat when present, and said polyurethane backing is a reactive polyurethane mixture comprising:
(1) at least one polyisocyanate component,
(2) at least one isocyanate-reactive component,
(3) at least one non-Newtonian thickener, and
(4) at least one filler; and
(C) a woven secondary backing which is laminated to the back surface of said polyurethane backing;
wherein the pattern is formed by the application of pressure or force to the face of the tufted good in a manner that pushes some of the polyurethane coating through the windows of the woven secondary backing.
